(19) United States
(12) Patent Application Publication
(10) Pub. No.: US 2015/0266710 A1
(43) Pub. Date: Sep. 24, 2015

(54) Flat bar opener

(71) Applicant: Paul Alan Camp, Hernando, MS (US)

(72) Inventor: Paul Alan Camp, Hernando, MS (US)

(21) Appl. No.: 13/999,811

(22) Filed: Mar. 24, 2014

(51) Int. Cl. B67B 7/16; B25F 1/00; B67B 7/44

(52) U.S. Cl. CPC B67B 7/16; B67B 7/44; B25F 1/00

(57) ABSTRACT

A flat bar opener used to remove crown caps wherein the opener has a hook to hold the opener on a clothing loop or pocket worn by the user in order to keep the opener in a readily retrievable position. Further provided are various tools distal to the cap removal aperture. Also the invention may be practiced with a tool alternate to a cap removal aperture.

### CROSS-REFERENCE TO RELATED APPLICATIONS

NOT APPLICABLE

### BACKGROUND OF THE INVENTION

The current invention relates to crown-cap openers.

is Flat Bar openers for crown-cap removers are well known and very old in the art. The most basic form is a generally rectangular strip of metal with rounded ends and one end defining an aperture adaptive to removing crown-caps. An opposite end aperture is often added.

A problem of the prevalent round end rectilinear shape of openers is that when stored in a pocket of the users clothing the bar will tend to slide to the bottom of the pocket and often turn across the bottom of the pocket inhibiting the quick removal of the opener.

Observation of bar operations quickly reveals that the users of the openers often utilize them in the manner of a “worry stone” tending to twirl the flat bar around their index finger via an opposite end aperture most often circular and opposite the crown-cap opener aperture. This activity would also appear to be bartender shtick expected by patrons. However, when the user simply clasps the bar with the index finger still inserted, the opener aperture would extend from their hand opposite their thumb which is not conducive to fitting on a cap or its removal.

### BRIEF SUMMARY OF THE INVENTION

The current invention provides a side exit channel defined by the opener body between the end apertures which forms a hook shape to be hung on a clothing loop or pocket lip. Another embodiment provides a side extended region which forms a hook for the same purpose. The closed semicircular end of the hook provides a means to twirl the opener about a finger and when clasped the opener will be at the thumb side of the user's hand and immediately useful to remove crown caps. Both of these embodiments may be practiced with one or more secondary tools defined on the bar body or a primary tool entirely different than the crown-cap opener on the proximal end. These secondary tools being companionate to fit objects including but, not limited to: a hex shape bolt, nut or valve stem; round shaft valve stem with formed opposite flat sides etc. The secondary tools may be of regular or irregular shapes. In defining the shape of an aperture or perimeter of a raised area to be used as a tool the term “regular shape” is intended to be those having commonly geometrically described and perhaps repetitive including but, not limited to, square, rectangular, multisided, splined and those shapes modified with a curved section or internal or external notches or tabs. The term “irregular shape” is utilized as those shapes that although may be descried mathematically are not completely repetitive in pattern. Those tools may be defined and further include defining a channel from the aperture shape through the distal end of the bar creating an open throat as an open end wrench or line wrench as known in the mechanical arts. The outer perimeter of the flat bar may also define yet another tool which requires a blade shape scraper, flat screwdriver or pry bar.

As best perceived from FIG. 1 the first embodiment presents a side hook described by the body of the opener. And best perceived from FIG. 2 the second embodiment the opener has a hook extended from one edge. The closed end of the hook would most often be semicircular but is not limited to that shape. It may be angular including but not limited to, three sides of a hex, forming a tool which may include a portion of the length of the hook and edge of the bar and still twirled about a finger. Chiefly it must be of a shape that will not tend to snag or cut skin, no sharp points or edges. This design would be conducive to making the aperture or outer perimeter opposite the cap opener into a specific tool including but, not limited to, a smaller complete hex or other shape aperture or the outer perimeter forming a wedge shaped pry bar. The objective of this invention is to accomplish at least one of the following: to provide a convenient means to hang the flat bar on the opening of a clothing feature of the user and provide an alternate finger interface conducive to using the bar by the user simply closing their hand to grip and to make more conducive to make the bar end opposite the crown-cap opener into another tool shape.

### BRIEF DESCRIPTION OF THE SEVERAL VIEWS OF THE DRAWING

FIG. 1 shows crown cap opener 1 with hook finger 10.

FIG. 2 shows crown cap opener 2 with side hook 12.

FIG. 3 shows crown cap opener 16 with distal outer tool 17.

FIG. 4 shows crown cap opener 18 with distal tool hex aperture 19 and third tool 20.

FIG. 5 shows crown cap opener 21 with open end tool 23.

FIG. 6 shows crown cap opener 25 with raised hex tool 26 with raised tool aperture 27.

### DETAILED DESCRIPTION OF THE INVENTION

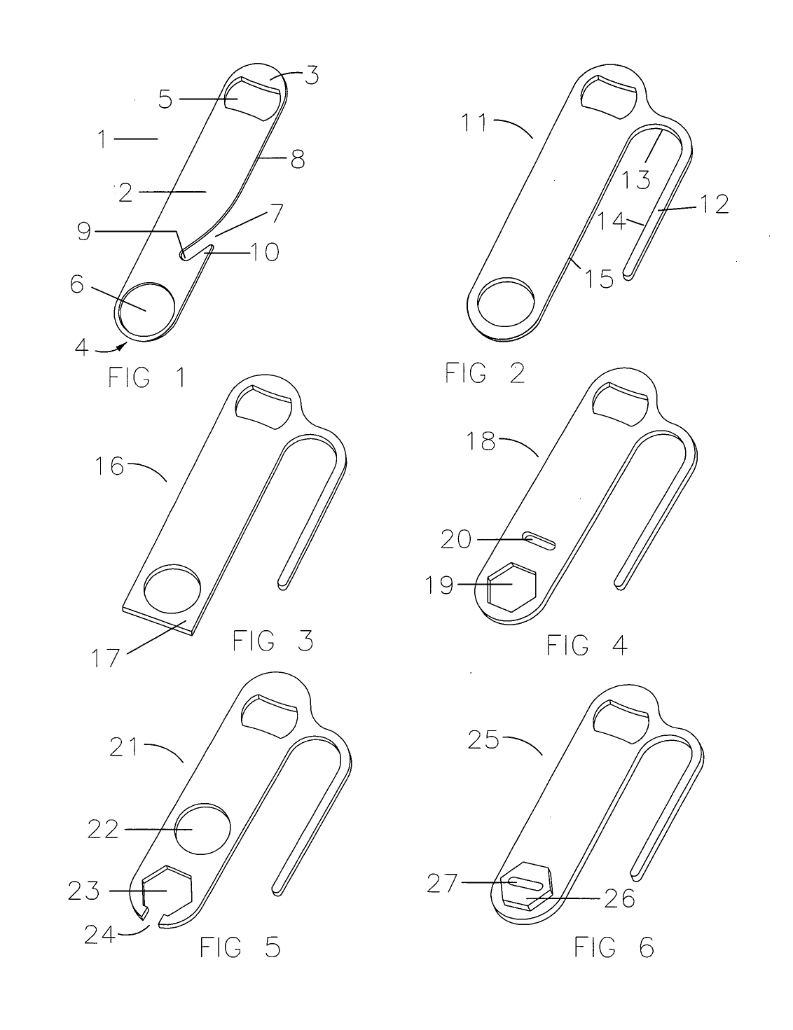

Referring to FIG. 1, a first embodiment of the crown cap opener 1 is shown in perspective view having bar body 2 being a generally flat rectangular portion with proximal end 3, cap aperture 5, distal end 4, and distal aperture 6. Many variations of cap aperture 5 are old and well known in the art. Bar body 2 further defines an open end channel 7 exiting on edge 8 having semicircular closed end 9 wherein the region between the channel and the edge 8 of bar body 2 forms hook finger 10. The user slides the bar body 2 inside a loop or pocket on their clothing leaving hook finger 10 outside the loop or pocket in order to maintain the crown cap opener in a readily accessible position.

Referring to FIG. 2, a second embodiment of the crown cap opener 2 is shown in perspective view. Having the elements of FIG. 1. 2 through 6 excluding the elements 7 through 10 but further including the inventive side hook 12 extending from an edge near proximal end 3 having hook closed end 13 being semicircular. Closed end 13 may also have an angular profile and in combination with hook inner edge 14 and bar body edge 15 forming 4 of the 6 sides of a hex. Closed end 13 and its adjacent edges should not be keen nor have burrs that would tend to snag or cut human skin. Again, The user slides the bar body 2 inside a loop or pocket on their clothing leaving side hook 12 outside the loop or pocket in order to maintain the crown cap opener in a readily accessible position. The user may also hang the opener on a finger by resting closed end 13 and may twirl the opener about the finger.

Referring to FIG. 3, a third embodiment of the crown cap opener is shown in perspective view having the elements of the second embodiment of FIG. 2 plus the inventive distal outer tool 17. Outer tool 17 has a mostly rectilinear profile which may be used as a blade screwdriver, scraper, pry bar or to break packaging.

Referring to FIG. 4, a fourth embodiment of the crown cap opener is shown in perspective view having the elements of the second embodiment of FIG. 2 plus the profile of distal aperture 6 now being the inventive distal hex aperture 19 being companionate to an outer hex profile object which the user desires to apply torque in the manner of a closed end wrench to a nut, bolt, fitting or valve. Although named as a specific geometric shape, hex, the aperture may be of other non-circular shapes. Also shown is inventive third tool aperture 20 shown as a round end rectangular slot which may be used to operate a valve stem having opposing flat surfaces for operating. Likewise, third tool aperture 20 may be of another non circular profile companionate to the outer profile of an object which the user desires to apply torque.

Referring to FIG. 5, a fifth embodiment of the crown cap opener is shown in perspective view having the elements of the second embodiment of FIG. 2 plus the inventive distal open tool 23. As shown distal tool 23 has the profile of a line wrench as known in the mechanical arts which engages all 6 surfaces of a hex but having an distal channel 24 open to pass over a fluid line or stem. The opening of the distal open tool 23 may be expanded and the hex profile rotated to the shape of an open ended wrench also known in the mechanical arts. Again the profile of distal open tool 23 may be of other noncircular profiles. Inventive intermediate aperture 22 is shown having a circular profile. Again, the intermediate aperture 22 may be of a noncircular profile as intermediate third tool aperture 20 companionate to the outer profile of an object which the user desires to apply torque.

Referring to FIG. 6, a sixth embodiment of the crown cap opener is shown in perspective view having the elements of the second embodiment of FIG. 2 plus the inventive distal raised tool 26 whose profile is companionate to an internal profile of an object which the user desires to apply torque. Again, although shown as a specific geometric shape, hex, the raised tool may be of other non-circular shapes. Also shown is inventive raised tool aperture 27 shown as a round end rectangular slot which may be used to operate a valve stem having opposing flat surfaces for operating. Once again, the raised tool aperture 27 may be of another non circular profile companionate to the outer profile of an object which the user desires to apply torque or a profile to accommodate passing the raised tool over a stem and further may have an open end as 24 of FIG. 5.

I claim:

1. A crown cap opener system comprising a bar body and hook, users clothing and user finger, said bar body comprising a generally flat bar having a length, greater than its width, greater than its thickness, proximal and distal ends,
said proximal end defining a cap aperture adaptive to removing a crown cap,
said distal end defining a substantially circular distal aperture,
said hook defined by a side exit open end channel defined by said bar body having a substantially semicircular closed end proximal to said bar body's center line,
said bar body region between said channel and side defining a hook finger,
said user's clothing including one or more loops or pockets,
said user storing said bar by sliding said bar body of said opener inside a loop or pocket on said clothing while said hook is positioned outside said loop or pocket, and
during times said opener is in said user's hand but not being used to remove caps,
said user inserting said finger inside said hook allowing said semicircular closed end rest on said finger and twirling said bottle opener.

2. A crown cap opener system comprising a bar body and side hook, users clothing and user finger,
said bar body comprising a generally flat bar having a length, greater than its width, greater than its thickness, proximal and distal ends,
said proximal end defining a cap aperture adaptive to removing a crown cap,
said distal end defining a substantially circular distal aperture,
said side hook comprising an extended region on an edge of said bar body near said proximal end
said extended region comprising a non-symmetrical extended area, as compared to a center line extending from the center of said cap aperture to the center of said distal aperture, extending from one bar body edge defining a hook having an open end opening toward said bar distal end and substantially semicircular closed end proximal to said bar proximal end,
said user's clothing including one or more loops or pockets,
said user storing said bar by sliding said bar body of said opener inside a loop or pocket on said clothing while said side hook is positioned outside said loop or pocket, and during times said opener is in said user's hand but not being used to remove caps,
said user may elect to insert said finger inside said side hook allowing said semicircular closed end rest on said finger and twirling said bottle opener.

3. The crown cap opener system of claim 2 wherein said distal end comprises a distal outer tool having a generally rectangular profile.

4. The crown cap opener system of claim 2 wherein said distal aperture defines a shape companionate to the outer mold line shape of a fastener or fitting which said user desires to apply torque.

5. The crown cap opener system of claim 2 wherein said distal aperture defines a hexagon companionate to the hexagon outer mold line shape of a fastener or fitting which said user desires to apply torque.

6. The crown cap opener system of claim 2 wherein said distal aperture defines a hexagon companionate to the hexagon outer mold line shape of a fastener or fitting which said user desires to apply torque and the bar body proximal to said distal end defines an intermediate aperture.

7. The crown cap opener system of claim 2 wherein said distal aperture defines a hexagon companionate to the hexagon outer mold line shape of a fastener or fitting which said user desires to apply torque and the bar body proximal to said distal end defines a third tool aperture companionate to the outer mold line shape of a fastener or fitting which said user desires to apply torque.

8. The crown cap opener system of claim 2 wherein said bar body distal area has a raised area distal raised tool which its outer profile defines an internal drive tool companionate to the inner mold line shape of a fastener or fitting which said user desires to apply torque.

9. The crown cap opener system of claim 2 wherein said distal aperture defines a distal open tool companionate to the outer mold line shape of a fastener or fitting which said user desires to apply torque and further defining a slot from the aperture through said distal end.

10. The crown cap opener system of claim 2 wherein said bar body distal area has a raised area distal raised tool which its outer profile defines an internal drive tool companionate to the inner mold line shape of a fastener or fitting which said user desires to apply torque and said raised area defines an raised tool aperture companionate to the external mold line shape of a fastener or fitting which said user desires to apply torque.

11. The crown cap opener system of claim 2 wherein said bar body distal area has a raised area which its outer profile defines an internal drive tool companionate to the inner mold line shape of a fastener or fitting which said user desires to apply and said raised area defines an aperture companionate to provide clearance around a fluid line or other object that would block access to said inner mold line shape torque and said distal end further having an opening extending through said raised area to said distal end.
